(19) United States
(12) Patent Application Publication
(10) Pub. No.: US 2025/0269956 A1
(43) Pub. Date: Aug. 28, 2025

(54) Compact Aircraft and Novel Methods of Manufacture Thereof

(71) Applicant: Brett Cryer, Pleasanton, CA (US)

(72) Inventor: Brett Cryer, Pleasanton, CA (US)

(21) Appl. No.: 18/588,672

(22) Filed: Feb. 27, 2024

(51) Int. Cl. B64C 3/38; B64D 27/02; B64U 10/25

(52) U.S. Cl. CPC B64C 31/028; B64C 3/22; B64C 3/56; B64D 27/08; B64C 2001/0081

(57) ABSTRACT

A compact fixed wing aircraft which may be folded or partially disassembled for ease of storage or transport. The aircraft engine(s) may telescopically slide into the fuselage for ease of transport or storage. The aircraft may feature two engines powering separate propellers in a coaxial counter-rotating propeller assembly. The aircraft may feature manufacturing improvements including load bearing truss structures cut from single sheets or plates of metals, the use of high strength metals, or the use of solid polymer sheets as a surface covering.

### CROSS REFERENCE TO RELATED APPLICATIONS

### Not Applicable

### STATEMENT REGARDING FEDERALLY SPONSORED RESEARCH/DEVELOPMENT

Not Applicable

### THE NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### STATEMENT REGARDING PRIOR DISCLOSURES BY THE INVENTOR OR A JOINT INVENTOR

Not Applicable

### BACKGROUND OF THE INVENTION

Since our earliest days humanity has gazed up into the sky and envied birds and their ability to fly. While hot air balloons were invented in the late 1700s and gliders in the mid 1800s, powered human flight remained elusive until the Wright brothers' historic flight at Kitty Hawk, North Carolina in 1903. Thereafter aircraft designs advanced rapidly. Early wood-and-fabric construction techniques were soon supplemented by aluminum stressed skin designs in the 1920s and 1930s, and by the end of World War II in 1945 huge fleets of high altitude heavy bombers with pressurized cabins ruled the skies, while simultaneously the first jet powered aircraft took to the air.

The post-war years were a boom for the aviation industry. There were many ex-military pilots among the population, and many thousands of small two and four seat general aviation aircraft were sold each year. But this time period also marked a bifurcation in aviation advancement. Military aircraft continued to evolve rapidly due to the Cold War, and substantial investments inspired continued innovation in materials, airframes, powerplants and avionics. However advancement in civil aviation slowed significantly, as the added complexity of newer technologies drove prices out of reach of the average man. Higher prices led to reduced sales, which led to reduced economies of scale for the light aircraft manufacturers, which led to still higher prices which further reduced sales, and this cycle continued for decades. This trend was amplified by a declining pilot population. Fewer military pilots were being trained than had been during World War II, and meanwhile more robust FAA standards increased the time and money required for a civilian to get a private pilot license. General aviation aircraft sales in the US eventually declined to less than 10% of their post war peak, and new product development stagnated accordingly. Even today a large portion of general aviation aircraft use either basic tube-and-fabric airframes or basic stressed-skin aluminum designs along with carbureted engines, technologies that would not have been out of place 60 years ago. Yet many of these general aviation aircraft cost as much as an exotic car or a modest house, such that civil aviation has been substantially relegated to a hobby for the wealthy.

One interesting exception to this are ultralight vehicles, as defined by Title 14 of the Code of Federal Regulations, Part 103. Powered ultralights came into being in the 1970s when hang glider pilots started attaching chainsaw motors with propellers to their aircraft in order to power them to heights from which they could begin their glides-no steep hill or cliff needed! Since these simple contraptions were so far below what was considered to be an aircraft at the time, the Federal Aviation Administration (FAA) was initially bewildered as to what to do about them. FAA eventually issued 14 CFR Part 103, which established the limits below which these “ultralight recreational vehicles” were not considered to be aircraft and hence are exempt from many of the FAA regulations. Key among these are that ultralights must have an empty weight of no more than 254 lbs, must be able to fly no faster than 55 knots (nautical miles per hour), have a stall speed of not more than 24 knots, carry at most 5 gallons of fuel, and may only carry the pilot but no other passengers. Since ultralight vehicles meeting the Part 103 requirements are not legally considered “aircraft”, they do not require registration, are not subject to the many mandatory safety inspections, and may be flown by persons without a pilot license. Together with the small and simple nature of the aircraft, the cost of purchasing and owning an ultralight aircraft was a small fraction of that of a general aviation aircraft. For those who wanted to experience recreational flight but did not have the time or money to get a pilot license and purchase a general aviation aircraft, ultralight vehicles were the perfect solution. They were also popular among older experienced pilots who lost their license due to medical issues.

For all their benefits with respect to ease of purchase and ownership, ultralights still suffer from many limitations. Ultralights are surprisingly large and bulky vehicles, most being some sort of a derivative of the powered hang glider with the pilot sitting in a fixed seat in a frame suspended underneath a large overhead wing. A few others resemble bare-bones all-aluminum general aviation aircraft. Both types are hard to store and transport, such that the owner needs to either rent a hanger or purchase a rather large trailer and appropriate vehicle to tow it with which the ultralight can be transported to and from the airfield. Ultralights are also lacking in comfort and potentially safety. In most designs the pilot is nearly fully exposed with the main mass of the aircraft above and behind him, which is the worst possible situation in the event of a hard landing or crash. Lastly, the big and draggy nature of the ultralight, combined with the commonly used thirsty 2-stroke engines and the 5 gallon fuel capacity limit means that the practical endurance and range of the ultralight is poor, usually 200 miles or less. Ultralight prices have also been increasing rapidly as material costs have soared in recent years.

What has been unavailable until now is a cost-effective aircraft design in which pilot comfort and safety are emphasized, which is fuel efficient to provide improved range and utility, and which is compact for ease of storage and transport. Other advantages of the invention will become apparent to those skilled in the art during the course of the following description.

### BRIEF SUMMARY OF THE INVENTION

The objective of the present invention is to describe several novel concepts in aircraft design and construction, which may be used individually or in combination to provide for an aircraft of superior performance, function, utility, and/or cost effectiveness. While these innovations are well suited for application to ultralight aircraft, their use in larger and more powerful general aviation aircraft as well as unmanned aerial vehicles, aka “drones”, is also viable and incorporated herein. This invention is intended only to include “fixed wing” powered aircraft and excludes unpowered gliders and all aircraft in which a significant portion of the lifting force comes from a lighter-than air-buoyancy (e.g. balloons and dirigibles) or rotating airfoils (e.g. helicopters, quad-copters, gyroplanes, and the like). The term “fixed wing aircraft” is herein defined as meaning any aircraft in which the majority of the lift force comes from the movement of air over one or more airfoils (wings) due to the movement of the aircraft through the air. The term fixed wing is not intended to limit the capability of the aircraft to adjust the alignment of any wings when the aircraft is in flight, for example variable sweep wings, or to limit the ability of the wings to be removed or repositioned with respect to the fuselage when the aircraft is on the ground. With respect to wing arrangement, variants of the aircraft envisioned include a conventional aircraft with a forward pair of wings, a canard aircraft design with the main wings towards the rear and smaller canards forward, and a tandem wing design with both a front pair of wings and a rear pair of wings. Any pair of wings may be single wings, aka “monoplane”, or may have a second or third wing above or below it creating a biplane or triplane. Any wings may be rigidly attached to the fuselage or be capable of variable geometry during or outside of flight. The general terms “aircraft” and “airplane” are used in the description below to encompass all of the above options.

In one embodiment of the present invention the aircraft is of a particularly compact design and major sections of the aircraft may be repositioned with respect to each other and/or entirely disassembled from each other for ease of transport and/or storage. These sections may include the fuselage (the central body of the aircraft), the empennage (the tail section), and the wings. Repositioning may include folding, rotating, swiveling, sweeping, or swinging the wings or tail substantially parallel to the fuselage. The sections may be repositioned adjacent to the fuselage or repositioned above or below it. This allows all components of the folded/disassembled aircraft to fit within a standard pickup truck bed or small car trailer, preferably with the tailgate up and otherwise at least without excessive overhang past the tailgate. Preferably the entire aircraft in the transport configuration fits within a single 1.22 meter×1.22 meter×2.44 meter (4 feet×4 feet×8 feet) or smaller crate for ease of storage or transport, making it approximately similar in size to a large motorcycle. For comparison, current manned aircraft designs which feature folding or collapsing parts still have extended linear components too large for convenient transport by pickup truck and thereby require a significantly larger trailer for transport or storage.

In another embodiment of the present invention the aircraft may be reduced in size for transport or storage by having one or more of the aircraft sections or components slide at least partially within another in a telescoping manner. In one example, an aircraft with an empennage can have the empennage slide within the fuselage to shorten the overall length of the aircraft. In another example, the engine can slide deeper within the fuselage, thereby shortening the fuselage section for transport or storage. In a preferred example, the propeller and any propeller gearing assembly slides with the engine, although in another example the propeller and/or gearing assembly are removed from the engine to allow the latter to slide further into the fuselage. Such sliding actions may result in the empennage or engine impinging into volume which during flight is used for crew or passenger legroom, for cargo, or for removeable fuel tanks, but which is unused during transport or storage. In another example the wings may telescope, such as by having an outer portion of the wing be able to slide within a more inner portion of the wing.

In another example, the design uses two engines to power the aircraft, such that if one engine fails or runs out of fuel the other will provide sufficient thrust to remain airborne until the operator can find a safe place to land. In a preferred example both engines power the same propeller so that failure of one engine does not cause a yaw moment as would occur if the engines are mounted on the wings. The use of two smaller tandem engines generating the same total horsepower as a single larger engine may allow for a more compact fuselage, thereby facilitating transport and storage of the aircraft. In one variant of this example each engine has an independent fuel supply and one engine has less fuel capacity than the other, ensuring that the two engines do not run out of fuel at the same time. In another variant of this example the aircraft uses coaxial counter-rotating propellers, with each propeller being independently driven by one engine. The counter-rotating propellers require less diameter to provide the same thrust as a single large propeller aiding transport and storage, and also balance out the yawing tendency associated with a single engine design. This aids ease of operation and reduces operator learning time. Mechanically the rear engine would drive the inner shaft and forward propeller, while the front engine drives a shorter outer shaft which over rides over the inner shaft and is connected to the rearward propeller.

In another embodiment of the present invention the aircraft is constructed using means which provide for a structure of superior strength, weight efficiency, and/or cost efficiency. In a first example of this embodiment, one or more of the major load bearing components of the airframe (for example fuselage frame, wing spar, or wing support) are substantially manufactured from single continuous piece of metal without bolts, welds, gussets, or other joints. These joints weaken the component by both creating stress risers within the metal tubes, beams, or spars being used as well as raising the risk of the bolt or weld breaking. This requires the various pieces comprising the component to be of heavier construction to compensate for these stress risers, which together with the added mass of the weld material, gussets, and/or fasteners significantly increases the weight of the structure. A superior option is to cut the entire component from a single sheet or plate of metal, such that the junctions are avoided. With this technique the positions of intersection of the various struts within the component can also be precisely engineered and manufactured to minimize the stresses within the part without adding unnecessary weight, for example by adding fillets and radii or by adding tapered reinforcements around holes. While many general aviation aircraft are too big for major structural components to be manufactured from a single metal sheet or plate (the length of the component exceeds that of the metal plates), or the amount of material drop from the cutting process would make such a manufacturing technique cost ineffective, the major sections of the compact aircraft design being described herein are small enough that this construction technique is both feasible and cost effective.

In a second example of this embodiment, one or more of the major load bearing structural components of the airframe (for example fuselage frame, wing spar, or wing support) are manufactured from a metal with a strength-to-weight ratio significantly superior to those currently in common use for aircraft construction. Such superior metals may include Aluminum 7075, titanium 6-4 Calloy, and high strength carbon steels. Use of these metals allows the components to be of lighter manufacture while still providing the required structural strength. In one example the superior metal is used in a conventional manner of aircraft construction, such as in a fuselage airframe structure assembled from bolted or welded tubes, or for a tubular or box beam wing spar structure. In a preferred example the aircraft is constructed by cutting one of more of the major load bearing components from a single sheet or plate of one of the superior metals.

In another embodiment of the invention, the surface of the aircraft is covered at least in part with a polymer skin of solid (not woven) polycarbonate, polyurethane, or nylon sheet, or another polymer of similar strength, flexibility, and/or tear resistance. Traditionally an aircraft's fuselage, empennage, and wings are covered with either linen or polyester woven cloth, or with aluminum, fiberglass, or carbon fiber. The cloth options are substantially unstressed and require a robust aircraft structure to support all the stresses applied to the aircraft during flight, but this method of manufacture is relatively simple and inexpensive. Aluminum, fiberglass, and carbon fiber coverings are typically stressed components which share a portion of the load on the fuselage or wing, thereby allowing for a stronger and/or lighter aircraft, but they can be significantly more expensive and/or difficult to manufacture. The polymer skin of the present invention provides a good balance of the other options-reasonably easy to manufacture and inexpensive, but strong enough to carry a load applied to the skin without being unacceptably heavy.

The compact aircraft of the present invention may also incorporate one or more of the safety features described below. While these features obviously would provide benefit to the pilot or passengers of a manned aircraft, they may also serve to improve the reliability of unmanned aerial vehicles, facilitate easy operation of the aircraft, and/or be protective of the delicate electronics and sensors required by an unmanned aircraft.

One safety feature of particular relevance to a manned ultralight is that the pilot is substantially enclosed within the fuselage, with the engine, propeller, and fuel tank all in front of him. In the event of a crash, this configuration provides much more protection to the pilot than a more traditional ultralight in which the main mass of the aircraft including the engine and fuel tank is above and/or behind the pilot, able to collapse down upon him if the airframe buckles. In one variant the pilot's head and shoulders protrude above the top of the fuselage, and they may be protected by a roll cage or roll bar. In another variant the pilot is entirely enclosed within the fuselage.

Another safety feature is that the compact aircraft of the present invention will typically have a wingspan of 6 meters (20 feet) or less [for example two 2.44 meter (8-foot) long wings and a 0.61 meter (2-foot) wide fuselage] such that in the event of an emergency the aircraft can reasonably attempt a safe landing on any two lane road sufficiently devoid of traffic. For comparison, most aircraft have a significantly greater wingspan such that if a landing on a two lane road was attempted the wings may strike obstacles on the side of the street such as parked vehicles, trees, mailboxes, streetlights, telephone poles, etc. which would risking spinning or flipping the fast moving aircraft. This allows the pilot of an aircraft of the present invention a much greater range of options to land safely in case of an emergency.

In a preferred example, the aircraft of the present invention features a canard or tandem wing design to provide superior stall resistance, and furthermore may feature a conventional tail with pitch and yaw controls for redundancy with any such controls provided by or mounted on the canard or wings. A further safety feature available with this layout is that the aircraft features a relatively low and rearward center of gravity. Combined with conventional tricycle landing gear, this allows for much greater braking forces to be applied to the main landing gear wheels without upsetting the pitch and direction of the landing aircraft, thereby reducing the amount of runway required for landing. In another example, the one more of the landing gear wheels have been replaced with a series of longitudinally aligned wheels akin to inline skates thereby increasing the runway contact area without increasing the frontal area and aerodynamic drag of the aircraft. In another example, these wheels are covered with a belt or track to further increase their runway contact area for improved braking and/or reduce ground pressure. In another example, the one or more wheels have been replaced with skids resulting in significant friction braking immediately upon landing and an absolute minimum landing distance.

In another example, the gas powered engine or engines(s) are augmented by one or more electric motors with sufficient power and battery life to provide at least several minutes of extra power. The weight and volume of this electric motor, speed control, and batteries may be less than that of a second engine, but the extra power is sufficient to substantially improve the takeoff and climb performance of the aircraft. The electric motor could also provide a few minutes of thrust in the event the main engine fails or runs out of fuel, allowing the pilot sufficient time to reach a safe landing area. In a preferred example the electric motor powers the same main propeller shaft as is powered by the gas engine(s), although they may also power their own propellers.

Another safety feature contemplated herein, useable in conjunction with a clear variant of the polymer skin concept described above, is to have the wings and/or fuselage underneath the skin illuminated, such that the overlying aircraft skin sheds light to make the aircraft more visible to other aircraft. The polymer skin may be completely transparent such that the light sources themselves are visible, or it may be semi-translucent due to thin or tinted paint such that the polymer skin diffuses the light passing through it.

In addition the above described novel safety features, the aircraft of the present invention would also feature many conventional safety features, such as an instrument panel with essential gauges (airspeed, altitude, stall speed, engine monitoring and fuel gauges, etc.), anti-collision lights and strobes, seatbelts, and a fire extinguisher. A radio to communicate with air traffic control and other pilots is also a highly preferred option.

### BRIEF DESCRIPTION OF THE DRAWINGS

FIG. 1 shows a side view of an example of a compact aircraft of the present invention in the flight configuration.

FIG. 2 shows a top view of an example of a compact aircraft of the present invention in the flight configuration.

FIG. 3 shows a side view of an example of a compact aircraft of the present invention in the transport configuration.

FIG. 4 shows a top view of an example of a compact aircraft of the present invention in the transport configuration.

FIG. 5 shows a top view of an example of a compact aircraft of the present invention in the transport condition, as loaded into a crate for transport or storage.

FIG. 6 shows a top view of an example of a compact aircraft of the present invention featuring a telescoping engine mount, with the engine in the transport position.

FIG. 7 shows a top view of an example of a compact aircraft of the present invention featuring a telescoping engine mount, with the engine in the flight position.

FIG. 8 shows side view of an example of a twin engine configuration of an aircraft of the present invention in which the two engines are driving counter-rotating propellers.

FIG. 9 shows a flat metal sheet which has been cut into a single-piece wing spar.

FIG. 10 shows a flat metal plate which has been cut into a single-piece fuselage frame side.

### DETAILED DESCRIPTION OF THE INVENTION

Referring to the drawings, in which similar numerals designate like parts throughout the drawings,

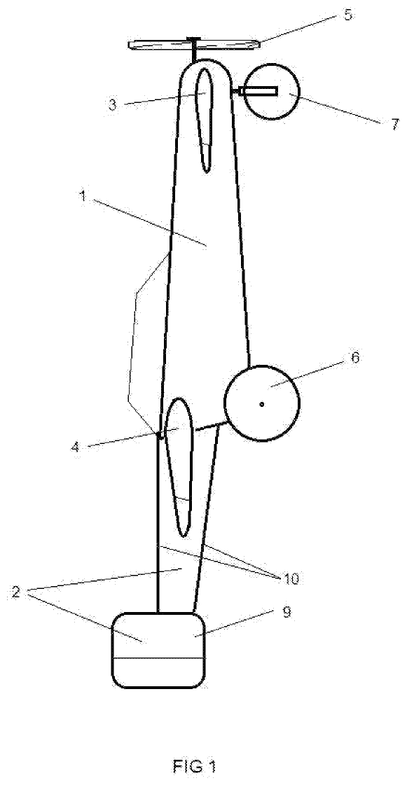

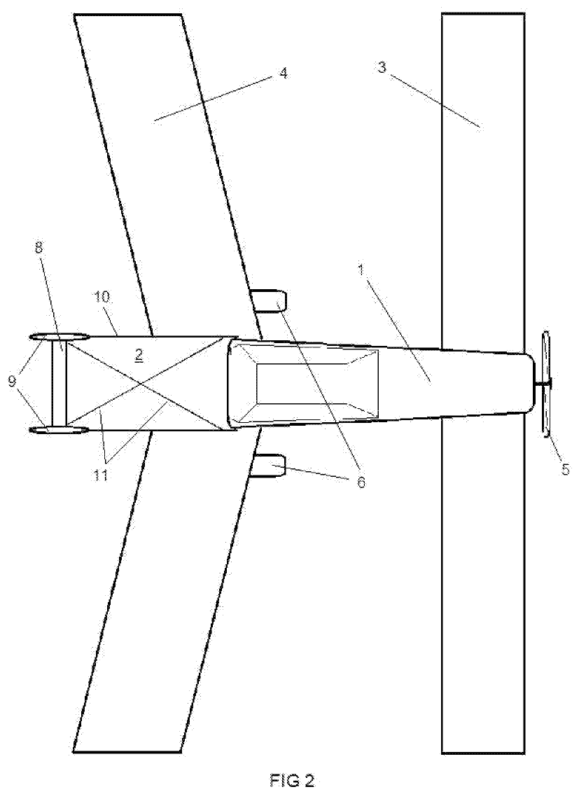

FIGS. 1 and 2 show an example of a compact aircraft of the present invention. The aircraft comprises a fuselage 1, a tail 2, forward wings 3, rearward wings 4, a propeller 5, main landing gear 6, and a nosewheel 7. The fuselage 1, also referred to as the main body of the aircraft, comprises a fuselage structure and skin and contains the cockpit for the pilot and engine. The tail 2, also referred to as the empennage, comprises the horizontal stabilizer(s) 8, vertical stabilizer(s) 9, and tail supporting structure 10. The tail supporting structure 10 may consist of exposed struts or trusses and may be uncovered or covered for aerodynamic efficiency. It may or may not feature bracing wires 11 for added stiffness.

The example shown in FIGS. 1 and 2 is a tandem wing design with forward wings 3 and rearward wings 4, both providing a significant portion of the lifting force on the aircraft. In another example the forward wings are significantly smaller than the rear wings and would conventionally be called canards while the rearward wings are larger and are responsible for providing a greater portion of the lifting force. In another example the aircraft has only one pair of main wings located more centrally along the fuselage and is more akin to a conventional aircraft. In another example one or more wings are paired creating a biplane. In another example one or more wings are in triplicate creating a triplane. Any wings may be straight like the forward wings 3 are shown to be in FIGS. 1 and 2, or they may be swept forward or back, like the rearward wings 4 are shown to be in FIGS. 1 and 2. The wings may be rectangular, tapered, elliptical, or other shapes in planform. In the most common example, the tail comprises conventional horizontal and vertical stabilizers, although in other examples these functions may be combined into an upright or inverted V tail. In another example the tail is omitted entirely, as is common with canard and tandem wing aircraft designs. The novel features of the present invention are independent from the layout of the aircraft.

The aircraft depicted in FIGS. 1 and 2 is shown in the flight configuration in which the wings and tail are attached to the fuselage in a means by which they are capable of supporting the aerodynamic forces applied to them during flight. In the example shown the wings are able to be entirely detached from the fuselage, while the tail is able to be swung up and over the fuselage. In other examples repositioning of the wings or tail for transport or storage may include folding, rotating, swiveling, sweeping, and/or swinging the wings or tail substantially parallel to the fuselage. The sections may be repositioned adjacent to the fuselage or repositioned above or below it. When the wings and tail have been detached or repositioned to be substantially parallel to the fuselage the aircraft is referred to as being in the transport configuration.

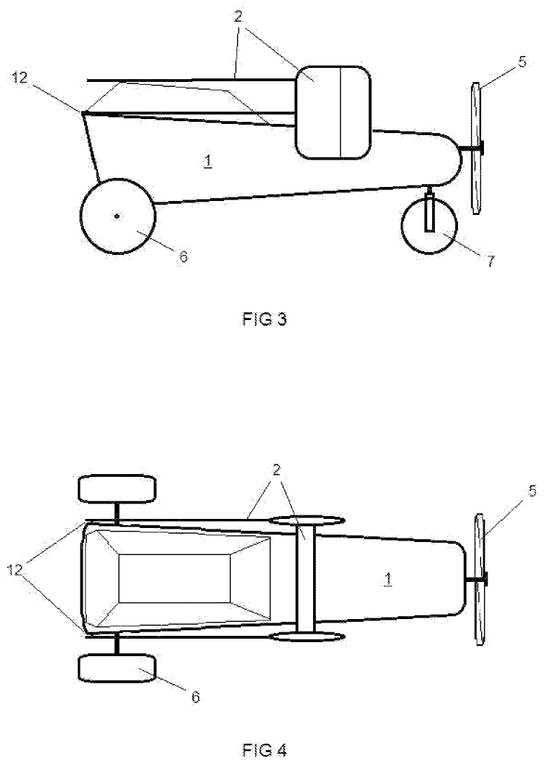

FIGS. 3 and 4 show the example aircraft of FIGS. 1 and 2 in the transport configuration, in which the wings have been detached and the tail 2 has been folded over the fuselage 1 at swivel points 12 thereby reducing the overall size of the aircraft for transport or storage. Detachment of the wings may be achieved with common hand tools in less than an hour and does not require a major deconstruction of the aircraft. In a preferred example the aircraft in the transport configuration is of sufficiently small dimensions that the aircraft can fit within the back of pickup truck or a small trailer easily towed by any passenger vehicle. In the preferred example the aircraft in the transport configuration is less than 3.66 meters (12 feet) in length, more preferably is less than 3.05 meters (10 feet) in length, and most preferably is less than 2.44 meters (8 feet) in length. This allows for all components of the folded/disassembled aircraft to fit within a US-standard 2.44 meter (8 foot) long pickup truck bed or car trailer, with the tailgate up in the case of the most preferred version, or without excessive overhang past the tailgate in the case of the somewhat longer versions. Preferably the entire aircraft in the transport configuration fits within a single 1.22 meter×1.22 meter×2.44 meter (4 feet×4 feet×8 feet) or smaller crate for ease of transport or storage. In a preferred example the width of the outer edges of the main landing gear is also less than 1.22 meters (4 feet) in width to allow the aircraft to fit within this size crate without necessitating wheel removal. In another example the main landing gear can be folded or removed when the aircraft is in the transport configuration.

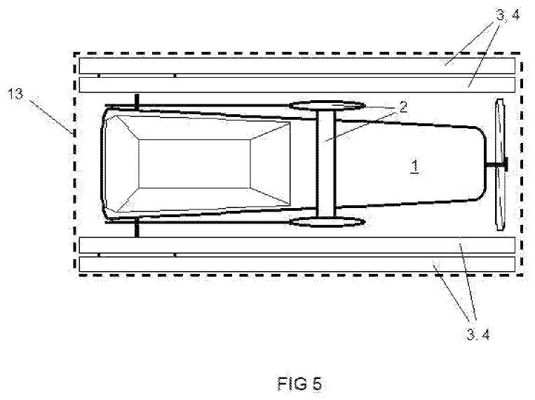

FIG. 5 shows the example aircraft of FIGS. 3 and 4 loaded into a crate 13 for transport or storage, in which the tail 2 has been folded over the fuselage 1 and the wings 3, 4 have been placed adjacent to the fuselage 1 and tail 2. The wings 3, 4 may be loose in the crate or rest within slots or brackets within the crate specifically designed to receive the wings. The wings 3, 4 may also rest on a brace permanently or removably attached to the fuselage 1 and/or main landing gear.

Sections which fold against each other may rotate in a single direction of motion around a hinge, rod or axle, or may be able to swivel in more than one direction of motion simultaneously due to the use of a ball-and-socket joint and/or multiple hinged joints. Examples of folding include having the empennage fold over the fuselage, having the empennage swing adjacent and parallel to the fuselage, having the wings rotate vertical and then fold parallel to the fuselage, or having the wings swivel towards each other in a swept-wing fashion until they are substantially parallel to and possibly overlapping the fuselage. A section may be able to be folded within itself, for example having an outer portion of a wing fold over or under an inner portion of a wing.

In a preferred example screws, bolts, pins, or dowels are used to fasten removeable sections to each other and/or secure repositioned sections in position. These fasteners may be removable, or may be held in place in one or more of the sections by welding, press fitting, adhesive, magnets, mechanical bracing, or other means. The fasteners may secure directly into one or more sections (for example a screw being inserted through a hole in a wing spar and being threaded into a tapped hole in the wing support on the fuselage), or may penetrate through holes in both sections and be anchored in position with a nut, clip, cotter pin, cross pin, securement wire, or by other means. Spring mounted alignment pins, ball detents, magnets, tab-and-slot interfaces, and other means may be used to help align the sections during assembly or disassembly. Wires, cable, straps, and rigid rods may also be used to brace, secure, or otherwise hold the sections in position.

Due to the compact nature of the aircraft, internal volume within the fuselage is limited, restricting the space available for the engine, fuel, pilot, cargo, safety equipment, and other contents. One means to remedy this is to mount the engine and associated propeller assembly on a plate or other structure which can slide with respect to the fuselage. In the transport configuration the engine and propeller assembly is slid substantially within the fuselage to shorten the overall length of the fuselage, while in the flight configuration the engine and propeller assembly extends longitudinally from the fuselage, thereby vacating volume within the fuselage for use for fuel, cargo, or other needs. Extending the engine at least partially from within the fuselage may also improve ease of inspection and maintenance of the engine.

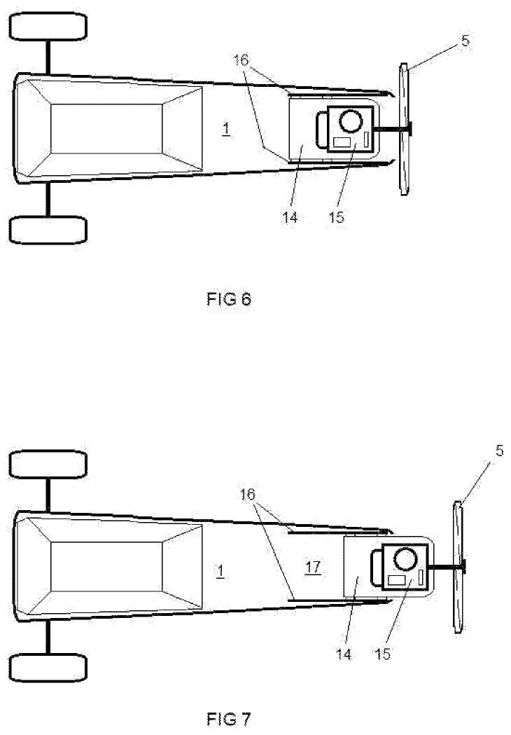

FIGS. 6 and 7 show an example of an aircraft featuring an engine mount 14 to which is attached the engine 15 and propeller 5 which can slide longitudinally along rails 16 affixed to the fuselage 1. FIG. 6 shows the aircraft with the engine 15 and propeller 5 in the transport configuration, while FIG. 7 shows the aircraft with the engine 15 and propeller 5 in the flight configuration. The wings and tail are omitted from FIGS. 6 and 7 for ease of viewing. Converting the aircraft from the transport condition to the flight condition vacates a volume 17 within the fuselage which may then be used for other purposes during flight. The sliding engine mount 14 and rails 16 can be in the forward part of the aircraft and associated with a tractor propeller configuration as shown in FIGS. 6 and 7, or be in the rear of the aircraft and associated with a pusher propeller configuration. The engine 15 may be powered by gasoline, diesel, alcohol, or other fuels, may be an electric motor, or may be a hybrid. The sliding rail may carry more than one engine and/or electric motor.

In one example the rails are made of a rod or tube and the engine mount slides over them along ring-shaped linear bearings. In another example the rails have a C, U, L, or T shape and the engine mount slides along them directly or on sliding contact pads. The engine mount may feature rollers which allow it to slide along any type of rail. In one example the engine is changed from the flight configuration to the transport configuration or (vice versa) manually and once in the desired position of travel it is held in place by clamps, hooks, bolts, or other method of securement. In another example the configuration change is operated via pneumatic or hydraulic means and may be secured at the desired position of travel by one of the methods described above or by the pressure within the pneumatic or hydraulic operation system. The rails may be made from a variety of materials, but preferably are made from aluminum, steel, stainless steel, titanium, or rigid cast fiberglass or carbon fiber. In a preferred example the front covering of the fuselage telescopes forward/backward along with the engine to maintain the aerodynamic efficiency of the engine, but the covering may also be a separate piece attached once the engine is in position, or may be omitted entirely to allow for the motion of the engine with respect to the fuselage.

In order to facilitate the breakdown of the aircraft from the flight configuration to the transport configuration it is desirable to maintain a propeller diameter that would fit within the confines of the storage area such that the propeller does not need to be removed. For example, to fit within a storage crate with interior dimensions of 1.19 meters×1.19 meters×2.41 meters (47″×47″×95″) would require the propeller to be not greater than 1.68 meters (66″) in diameter, and that would require a perfect diagonal alignment and for the centerline of the propeller to match the centerline of the crate. Realistically the propeller would need to be smaller than this. In a preferred example the propeller has a diameter of 1.19 meters (47″) or less. Smaller diameter propellers have less swept area and require higher rotational speeds to provide the same thrust. One solution to this it to use multiple propellers on the same shaft.

FIG. 8 shows a preferred example of an arrangement by which multiple propellers are mounted on the same shaft. A fixed or sliding engine mount 18 holds two engines 19 and 20 which drive two propellers 21 and 22. The rearward engine 19 powers the front propeller 22 via a speed adjustment system 23 connecting the engine 19 to the inner drive shaft 24. In a preferred example the speed adjustment system is a geared transmission, a chain drive, or a belt drive, and may either increase or decrease the drive ratio of the engine output shaft and the inner drive shaft 24 such that the speed of the propeller is optimized with respect to the speed of the engine. The forward engine 20 powers the rear propeller 21 via a speed adjustment system 25 connecting the engine 20 to a tubular outer drive shaft 26 which is mounted over and able to rotate independently of the inner drive shaft 24.

The primary advantages of the system depicted in FIG. 8 are twofold. First, each engine drives its own propeller independent of the other, such that if either engine fails the other engine and propeller continues to operate normally. If the rearward engine fails, the inner drive shaft 24 may come to a halt (or may continue to spin due to aerodynamic forces acting upon the propeller 22) but the forward engine 20, outer drive shaft 26, and rearward propeller 21 will continue to operate unhindered, spinning the outer drive shaft 26 around the inner drive shaft 24 regardless of whether the inner drive shaft 24 is stationary or rotating. Likewise if the forward engine fails the rearward engine and connected propeller will continue to operate without issue. This redundancy represents an important safety feature as only if both engines fail at the same time will the aircraft entirely lose power. If one of the engines fails the other should provide sufficient power for the pilot to safely fly and land the aircraft. The other advantage of the system shown in FIG. 8 is that the engines can be geared or turned 180 degrees with respect to the other such that the propellers rotate in opposite directions. Counter-rotating propellers are known to provide more efficient thrust for the power applied, in part because the downwash from the forward propeller causes the air impacting the rearward propeller to contact the rear propeller blades at a more favorable angle of attack. While aircraft with counter-rotating propellers date back many decades, historically both propellers are driven by a single engine and the counter-rotation is a result of complicated gearing. The use of two engines in an arrangement as shown is FIG. 8 is simpler, novel, and superior.

In order to further optimize the performance of the aircraft of the present invention, superior methods of manufacture may be employed. One area in particular in which the performance may be improved over conventional aircraft designs is by the use of superior construction techniques and/or materials in the load bearing structures of the aircraft which allow for the aircraft to be made lighter and/or eliminate the need for supporting struts and wires. One key load bearing structure is the fuselage airframe to which the engine, wings, and landing gear are attached. Another key load bearing structure is the wing spar used to provide shape to the wing and to transmit the aerodynamic and momentum forces applied to the wing to the fuselage. Conventional aircraft typically use airframes assembled from a number of metal struts, typically of aluminum or steel. The struts are often round or square tubes, but “I”, “T”, and other cross-sectional shapes have been used. Aluminum airframes typically have an aluminum aircraft skin riveted to them thereby giving a rigid stressed-skin combined structure, while steel tubes are typically bolted or welded to each other to form a rigid truss structure to which a fabric or other covering is applied. Every junction between parts, including but not limited to bolt, rivet, and weld points, are stress risers and represent weak points in the structure which either reduce the overall strength of the structure or require it to be more heavily built to compensate for the stress risers. Both detract from aircraft performance. Similarly, wing spars are often made from either a single larger diameter aluminum or steel beam or tube, or a truss structure assembled from multiple smaller beams or tubes. The single beam/tube wing spars are weight inefficient because the forces applied to the wing are not uniform around the circumference of the wing, while truss-type spars have joints and attachment points which need to be overdesigned to compensate for these stress risers. Assembly of any airframe, wing spar, or other load bearing structure from multiple smaller pieces is also relatively labor intensive and therefore expensive.

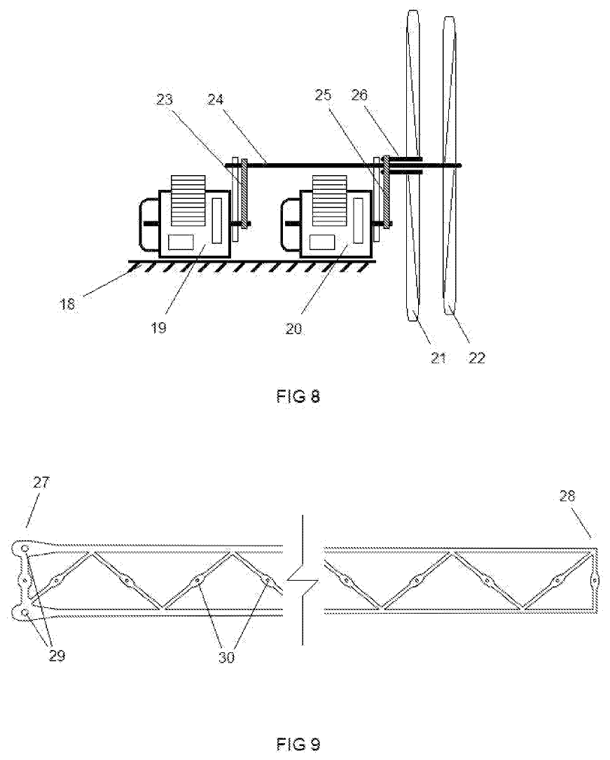

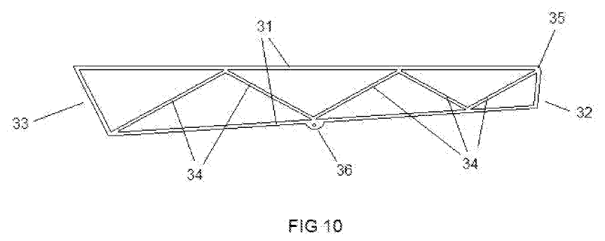

One superior method of manufacture is to cut the structure from a single piece of metal, thereby omitting the need for the joining of multiple pieces and the associated stress risers, weak points, and compensatory extra mass. In a preferred example, the structure is cut from a single flat plate or sheet of metal. Typically flat metal is referred to as “plate” starting at about 5 mm (0.20″) in thickness, while thinner material is referred to as “sheet”. Depending on the application and material used, metals in both thickness ranges are applicable to the superior method of manufacture disclosed here. FIGS. 9 and 10 show examples of load bearing structures which are cut from a single sheet or plate of metal.

FIG. 9 shows an example of a truss structure used for a wing spar. Due to the length of the spar the middle portion has been omitted for ease of viewing. The structure features a wing root end 27 and a wing tip end 28. It can be seen that the thickness of the horizontal upper and lower struts tapers from a greater thickness (or height or cross section) at the wing root end of the structure to a lower thickness (or height or cross section) at the wing tip end of the structure. The type and amount of taper may vary, preferably being designed so that each section of the truss has a similar material stress and therefore the overall structure can be as thin and light as possible without having areas of excess cross-section and mass. In the example shown the taper is linear, although exponentially thinning struts are also envisioned. The example structure further features holes 29 for attachment to the fuselage wing support, and other holes 30 to which additional structures and/or wing ribs, flaps, ailerons, slats, slots, or other things may be attached. It can be seen that the areas around these holes have been selectively reinforced to compensate for the stress risers induced by the holes, without excess mass being added elsewhere in the structure. Likewise the areas where the horizontal, vertical, and diagonal struts intersect have been reinforced as necessary and radiused to reduce stress at the junctions.

FIG. 10 shows an example of a truss structure used for one side of the fuselage frame. The structure comprises two substantially longitudinal struts 31, a forward vertical strut 32, a rearward vertical strut 33, and five diagonal bracing struts 34. The points at which the struts intersect such as the example at position 35 are continuous metal and feature radii to smooth the stresses transmitted between the struts resulting in a strong and rigid structure. In an aircraft design with a forward mounted engine the forward vertical strut 32 and forward portion of the longitudinal struts 31 may be wider than the other struts in order to handle the weight and power of the engine. The one piece design allows this to be done seamlessly and then the thicker areas can be tapered smoothly into the rest of the structure, whereas an airframe assembled from multiple separate struts would be less efficient due to having the thicker or larger struts supporting the engine being joined to thinner or smaller struts outside the higher load forward area. The example truss structure shown in FIG. 10 also incorporates a reinforced area 36 to which the aircraft landing gear will be attached. As above, this reinforced area is seamlessly a part of the overall structure and is therefore more weight efficient than would be the case if it was assembled from different struts or pieces.

Examples of means by which the load bearing structures may be manufactured from a single sheet or plate of metal include but are not limited to plasma cutting, laser cutting, waterjet cutting, and computer numerical control (CNC) machining. The structure may also be stamped or sheared. In another example the structure is cast as a single piece of material. In another example the structure is cast into the approximate shape and then further cut to the final shape, such as may be desirable to reduce material wastage. Secondary operations after cutting would typically include sanding or grinding the cut edges to remove burrs, slag, and sharp edges from the cutting process, followed by sanding the part to clean the surface prior to coating. The parts may be treated with a zinc phosphate or other solution to help resist corrosion. The cut structure may then be painted, powder coated, spray coated with a polyurea protective polymer, or otherwise have the surface covered for cosmetic reasons and to improve corrosion resistance. The cut structure may remain flat or be further bent or pressed into a desired shape. For example, a fuselage which features a longitudinal load bearing structure similar to one shown in FIG. 10 running down each side of the fuselage may have each structure pressed into a semi-circular shape to give the fuselage a more aerodynamic profile when viewed from the front, and/or they may be bent towards each other at the front or back of the fuselage to yield a more tear-drop shape profile when viewed from the top.

Another superior method of manufacture is to manufacture one or more of the major load bearing structural components of the airframe (for example fuselage frame, wing spar, or wing support) from a metal with a strength-to-weight ratio significantly superior to those currently in common use for conventional aircraft construction. Use of such a metal allows the components to be of lighter manufacture while still providing the required structural strength. The metals conventionally used for aircraft construction include 2XXX and 6XXX series aluminum alloys, and “chrome moly” steels of the AISI 41XX family. Examples include Al 6061, Al 2024, and 4130 steel. The aluminums typically have ultimate tensile strengths of approximately 241-283 MegaPascals (35-41 kilopounds per square inch) and densities of approximately 2.7-2.8 grams per cubic centimeter (0.098-0.102 pounds per cubic inch). Chrome moly steel of the type commonly used for aircraft structures typically has an ultimate tensile strength of approximately 621 MPa (90 ksi) and a density of approximately 7.8 g/cc (0.28 lbs/in³). These metals all therefore have strength-to-weight ratios in the range of approximately 80-100 MPa per g/cc.

The metals with strength-to-weight ratios significantly superior to the above which are envisioned as part of this embodiment of this invention include Aluminum 7075, Grade 5 Titanium alloy (6% aluminum, 4% vanadium), and semi-hardened and hardened carbon steels having a Brinell Hardness of approximately 360 or greater and/or ultimate tensile strengths of approximately 1241 MPa (180 ksi) or greater. Preferred examples of the latter steels include AR400, AR500, MIL46100, and various similar proprietary grades of abrasion resistant and ballistic steels. While Al7075 and Ti 6-4 are known within the civilian aircraft industry, they have historically been used for high load parts such as landing gear and transmission components and not for the primary structural components. Aluminum 7075 has an ultimate tensile strength of approximately 503 MPA (73 ksi) and a density of approximately 2.8 g/cc (0.102 lbs/in³), giving it a strength-to-weight ratio of approximately 180 MPa per g/cc. Grade 5 titanium has an ultimate tensile strength of approximately 827 MPA (120 ksi) and a density of approximately 4.5 g/cc (0.16 lbs/in³), giving it a strength-to-weight ratio of approximately 184 MPa per g/cc. A hardened steel with an ultimate tensile strength of approximately 1241 MPA (180 ksi) and a density of approximately 7.8 g/cc (0.28 lbs/in³) has a strength-to-weight ratio of approximately 159 MPa per g/cc. Even stronger steels are available. The use of these metals with superior strength-to-weight ratios of 159-184 MPa per g/cc instead of conventional aircraft aluminums and steels with strength-to-weight ratios of 80-100 MPa per g/cc allows for the manufacture of significantly lighter and more efficient aircraft, while retaining the many advantages of metal such as isotropic behavior, resistance to aging, and ease of manufacture. Fiberglass and carbon fiber are very strong and weight efficient and are also used in aircraft construction, but they are quite expensive and can be more difficult to work with than metals.

The compact size of the aircraft, the use of metals with a superior strength-to-weight ratio, and the efficiency of having major structural components cut from a single piece of metal without joints together combine to provide for an exceptionally light airframe. Due to the light weight of the aircraft and strong structure, the airframe may incorporate one or more attachment points which allow the aircraft to be hoisted to the top of an automobile garage or aircraft hangar for convenient storage without disassembly, thereby allowing other vehicles or aircraft to be stored below it.

Another means by which the performance of the aircraft of the present invention may be improved over conventional aircraft designs is through the use of novel surface coverings. Traditionally the aircraft fuselage and wings are covered with either linen or polyester woven cloth, or with aluminum, fiberglass, or carbon fiber. The cloth options are substantially unstressed and require a robust aircraft structure to support all the stresses applied to the aircraft during flight, but they are simple to manufacture and relatively inexpensive. Aluminum, fiberglass, and carbon fiber coverings are typically stressed components which share a portion of the load on the fuselage or wing, thereby allowing for a stronger and/or lighter aircraft, but they can be substantially more expensive and/or difficult to manufacture. One novel means to improve upon this is to cover the aircraft surface with a polymer skin of solid (not woven) polycarbonate, polyurethane, or nylon sheet, or another polymer of similar strength, flexibility, and/or tear resistance. The polymer skin of the present invention provides a good balance of the other options-reasonably inexpensive and easy to apply like a cloth covering, but strong enough to carry some load applied to the skin without being unacceptably heavy. The solid polymer skin also provides for a more modern and aerodynamic appearance, as compared to the more vintage ribbed look of a cloth-over-frame construction.

In one example the polymer skin is less than or equal to 1/16″ (0.063″) in thickness, more preferably less than or equal to 0.040″ thick, and most preferably less than or equal to 0.030″ thick. It may be attached to the fuselage/empennage frame or wing ribs using any conventional means such as rivets, screws, adhesive, and lacing, and may also be thermally adhered (i.e. melted) onto the supporting structure. The polymer skin may be applied as flat sheets since it is flexible enough to conform to most curves of the aircraft, or it may be blow molded into a preferred shape prior to attachment. The polymer sheet may substantially cover the entire surface of the fuselage or wing, or may be used in selective areas, for example the cowl behind the engine and propeller or along the leading edge of the wing, both areas which may experience higher aerodynamic loads than other parts of the fuselage or wing. In this example the selective areas to which the polymer skin is applied may represent only 20% or 25% of the total surface area of the component.

In one example the polymer skin is made from polycarbonate since it is clear and strong and the skin is also formed into the windshield and/or side or back windows of the aircraft. These windows are a continuous part of the fuselage skin such that there are no seams between panels which could weaken the structure or create turbulence and drag in the airstream, and differ from adjacent skin material only in lacking paint. Because the windows may be subjected to higher loads from the incoming windblast, additional layers of polycarbonate or other clear materials may be laminated with them in order to provide the required strength and rigidity.

In another example the polymer skin is further covered with fiberglass or carbon fiber in order to provide a skin of even greater strength as may be needed for a high performance aircraft. While the latter material would carry the majority of the load, the polymer layer provides a smooth substrate upon which the fiberglass or carbon fiber can be easily applied, significantly simplifying layup of the fiber components and eliminating the need for wing or fuselage molds. The fiberglass or carbon fiber may be applied to either the outside or inside surface of the polymer skin, the latter most applicable to panels which have been molded or otherwise shaped prior to attachment to the aircraft surface.

In another example, the wings and control surfaces of the aircraft are covered with polycarbonate, while the fuselage and empennage are covered with shrink wrap, preferably heavy duty “marine grade” shrink wrap of 0.005″-0.007″ thick as is used to wrap watercraft. This places the polymer skin in the locations where its strength and robustness are of most benefit, while the lighter shrink wrap is used where loads on the skin are minimal. In another variant the fuselage and/or empennage are partially or substantially uncovered with the pilot, engine, and other contents of the central body of the aircraft exposed to the airstream.

The invention claimed is:

1. A manned, powered, fixed wing aircraft comprising at least a fuselage and one or more wings, in which the wings can be repositioned substantially parallel to the fuselage or entirely detached from the fuselage, and in which the length of the fuselage and each wing is 3.66 meters (12 feet) or less.

2. The aircraft of claim 1, in which the length of the fuselage and each wing is 3.05 meters (10 feet) or less.

3. The aircraft of claim 1, in which the length of the fuselage and each wing is 2.44 meters (8 feet) or less.

4. The aircraft of claim 1, in which the aircraft comprises a fuselage, an empennage, and one or more wings, in which the empennage and wings can be repositioned substantially parallel to the fuselage or entirely detached from the fuselage, and in which the length of the fuselage, empennage and each wing is 3.66 meters (12 feet) or less.

5. The aircraft of claim 4, in which the length of the fuselage, the empennage and each wing is 3.05 meters (10 feet) or less.

6. The aircraft of claim 4, in which the length of the fuselage, the empennage, and each wing is 2.44 meters (8 feet) or less.

7. A powered fixed wing aircraft which is adjustable between a transport configuration and a flight configuration, in which in the transport configuration the engine is substantially contained within the fuselage and which in the flight configuration the engine is slidably extended substantially out of the fuselage.

8. The aircraft of claim 7, in which two or more engines are able to be substantially slid within the fuselage in the transport configuration and at least one engine substantially extends from the fuselage in the flight configuration.

9. A powered fixed wing aircraft featuring an first engine powering a first drive shaft connected to a first propeller, a second engine powering a second drive shaft connected to a second propeller, in which the second drive shaft is tubular and is positioned over the first drive shaft, and in which the two propellers rotate in opposite directions.

10. The aircraft of claim 9, in which both propellers have a diameter of 1.19 meters (47″) or less.

11. A powered fixed wing aircraft comprising at least a fuselage and one or more wings, in which the primary load-bearing component(s) of the fuselage or a wing comprises a truss structure fabricated from a single continuous piece of metal with no welds or other joints between linear elements in the structure.

12. The aircraft of claim 11, in which the truss structure is plasma cut, laser cut, waterjet cut, or CNC machined from a single flat sheet or plate of metal.

13. The aircraft of claim 11, in which the aircraft is manned.

14. The aircraft of claim 11, in which the aircraft is unmanned.

15. A powered fixed wing aircraft comprising at least a fuselage and one or more wings, in which the structural frame of the fuselage or a wing is substantially fabricated from high strength steel with an ultimate tensile strength of at least 1241 MPA (180,000 psi).

16. The aircraft of claim 15, in which the aircraft is manned.

17. The aircraft of claim 15, in which the aircraft is unmanned.

18. A powered fixed wing aircraft comprising at least a fuselage and one or more wings, in which at least 20% of the surface area of the fuselage or wings comprises a covering of solid non-woven polymer sheet with a thickness of 0.063″ or less.

19. The aircraft of claim 18, in which the polymer sheet is polycarbonate, polyurethane, or nylon.

20. The aircraft of claim 18, in which the polymer sheet is transparent and also used in the formation of one or more windows in the fuselage.
